(19) United States
(12) Patent Application Publication
(10) Pub. No.: US 2021/0035730 A1
(43) Pub. Date: Feb. 4, 2021

(54) INDUCTOR

(71) Applicant: Murata Manufacturing Co., Ltd., Kyoto-fu (JP)

(72) Inventor: Yuta HACHIYA, Nagaokakyo-shi (JP)

(73) Assignee: Murata Manufacturing Co., Ltd., Kyoto-fu (JP)

(21) Appl. No.: 16/937,511

(22) Filed: Jul. 23, 2020

(30) Foreign Application Priority Data
Jul. 31, 2019 (JP) 2019-141355
May 1, 2020 (JP) 2020-081335

(51) Int. Cl. H01F 27/28; H01F 27/29; H01F 27/255; H01F 41/02; H01F 41/063

(52) U.S. Cl. CPC H01F 27/2823; H01F 27/29; H01F 41/063; H01F 41/0246; H01F 27/255

(57) ABSTRACT

An inductor includes a main body having a magnetic portion containing a magnetic powder and a coil embedded in the magnetic portion and also includes a pair of external electrodes disposed on the main body and electrically connected to the coil. The coil has a winding portion in which a conducting wire having a pair of wide surfaces are wound around a winding axis in such a manner that one end section is disposed at an innermost turn of the winding portion and the other end section is disposed at an outermost turn of the winding portion. The coil has a first lead portion is twisted and drawn outward from the innermost turn of beyond the outermost turn of the winding portion and also has a second lead section is drawn outward from the outermost turn of the winding portion.

### CROSS-REFERENCE TO RELATED APPLICATIONS

This application claims benefit of priority to Japanese Patent Application No. 2019-141355, filed Jul. 31, 2019, and to Japanese Patent Application No. 2020-081335, filed May 1, 2020, the entire contents of each are incorporated herein by reference.

### BACKGROUND

### Technical Field

The present disclosure relates to an inductor.

### Background Art

Size reduction of inductors to be used in electronic devices has been desired. A type of inductor to be used in electronic devices includes a coil formed by winding a single conducting wire around in upper and lower tiers and by drawing lead portion each outward from the outer periphery of upper and lower tiers of the coil (so-called “alpha-winding coil”). The inductor includes a magnetic portion covering the coil and also includes external electrodes connected to the coil. To reduce the size of such an inductor, for example, Japanese Unexamined Patent Application Publication No. 2015-225887 proposes an inductor in which end section of conducting wire that lead portions of the coil are bent in the magnetic portion so as to reduce a volume occupied by the lead portions.

Meanwhile, operating frequency of electronic devices has been increased in recent years in order to reduce power consumption. This enables the inductance of an inductor to be lowered and accordingly enables the coil to have a smaller number of windings. A decrease in the number of windings of the coil is advantageous for reducing the size of the inductor.

In the inductor having the alpha-winding coil as described in Japanese Unexamined Patent Application Publication No. 2015-225887, however, the height of the winding portion inevitably becomes greater than twice the width of the conducting wire. This makes it difficult to reduce the height of the inductor to a desired level and thereby difficult to reduce the overall size, depending on the width of the conducting wire to be used.

In addition, in the inductor having the alpha-winding coil as described in Japanese Unexamined Patent Application Publication No. 2015-225887, a flat wire having a rectangular cross section is used as the conducting wire. The flat wire has a cover layer and a fusing layer formed on the surface thereof. The turns of the conducting wire in the upper tier are adhered, by fusing layer, to the turns of the conducting wire in the lower tier. When the number of turns of the coil is reduced, in other words, the number of the turns in the upper and the lower tiers of the coil are reduced, the adhesion area between the upper turns and the lower turns is also reduced, which leads to insufficient bonding of turns of the conducting wire in the winding portion.

### SUMMARY

Accordingly, the present disclosure provides an inductor that enables the reduction of the height and the overall size thereof while turns of the conducting wire in the winding portion can be adhered sufficiently.

According to preferred embodiments of the present disclosure, an inductor includes a main body having a magnetic portion containing a magnetic powder and a coil embedded in the magnetic portion and also includes a pair of external electrodes disposed on the main body and electrically connected to the coil. The coil has a winding portion in which a conducting wire having a pair of wide surfaces are wound around a winding axis in such a manner that one end section is disposed at an innermost turn of the winding portion and the other end section is disposed at an outermost turn of the winding portion. The coil has a first lead portion in which the conducting wire drawn from the one end section of the winding portion is twisted and drawn outward from the innermost turn of the winding portion beyond the outermost turn of the winding portion and also has a second lead portion in which the conducting wire drawn from the other end section of the winding portion is drawn outward from the outermost turn of the winding portion. A height of the coil in a crossing region in which the first lead portion crosses the winding portion is smaller than twice a height of the winding portion.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view illustrating an inductor according to a first embodiment of the present disclosure;

FIG. 2 is a perspective view illustrating a coil in the inductor of FIG. 1;

FIG. 3A is a view for explaining an extent of torsion of a lead portion of the coil in the inductor, in which the torsion angle is set to be equal to an angle between a diagonal and a width-wise side in a cross section of a conducting wire;

FIG. 3B is another view for explaining the extent of torsion of the lead portion of the coil in the inductor, in which the torsion angle is set to be twice the angle between the diagonal and the width-wise side in the cross section of the conducting wire;

FIG. 3C is another view for explaining the extent of torsion of the lead portion of the coil in the inductor, in which the torsion angle is set to be greater than twice the angle between the diagonal and the width-wise side in the cross section of the conducting wire;

FIG. 3D is a view for explaining a relation between the torsion angle of the lead portion of the coil and the height of the lead portion in the inductor of FIG. 1;

FIG. 4 is a perspective view illustrating an inductor according to a second embodiment of the present disclosure; and

FIG. 5 is a perspective view illustrating a coil of the inductor of FIG. 4.

### DETAILED DESCRIPTION

Embodiments of the present disclosure will be described in detail with reference to the drawings. Note that terms related to specific directions and specific positions will be used when necessary in the following description (for example, “up”, “down”, “right”, “left”, and other terms containing such words). These terms are used for the sake of facilitating a clear understanding of the disclosure when it is described with reference to the drawings. However, these terms are not intended to limit the technical scope of the present disclosure. Elements or members denoted by the same reference symbols in the drawings indicate that such elements or members are identical.

Embodiments described later are based on the preceding description of embodiments, and accordingly only differences will be described and duplicated description will be omitted. Advantageous effects obtained by a similar configuration will not be described repeatedly for each embodiment.

### 1. First Embodiment

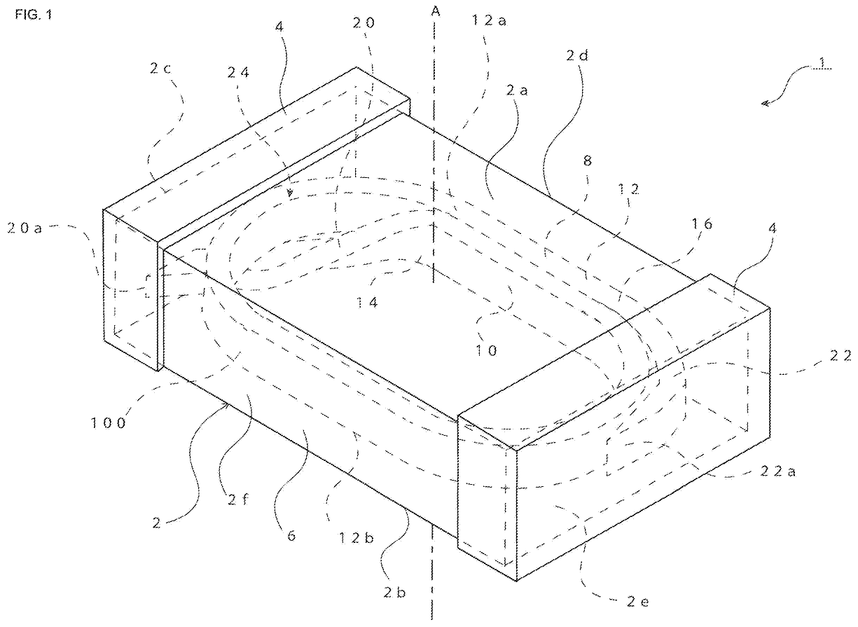

An inductor 1 according to a first embodiment of the present disclosure will be described with reference to FIGS. 1 to 3D.

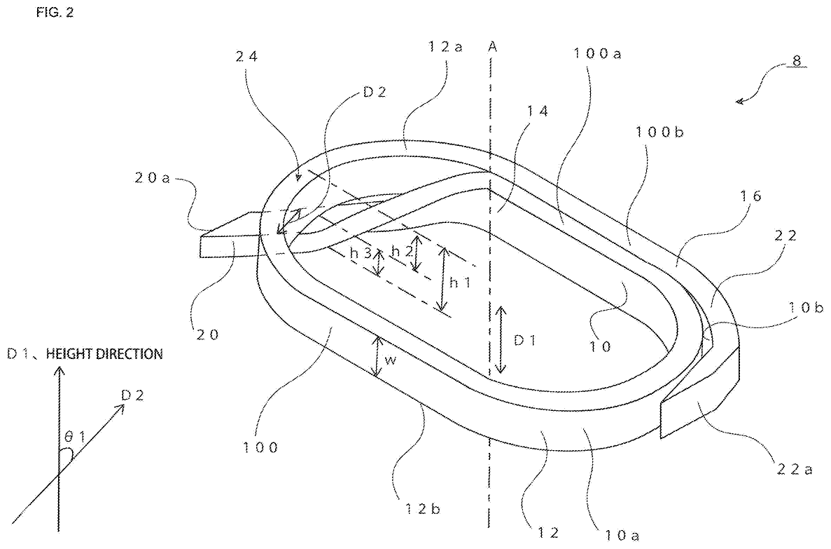

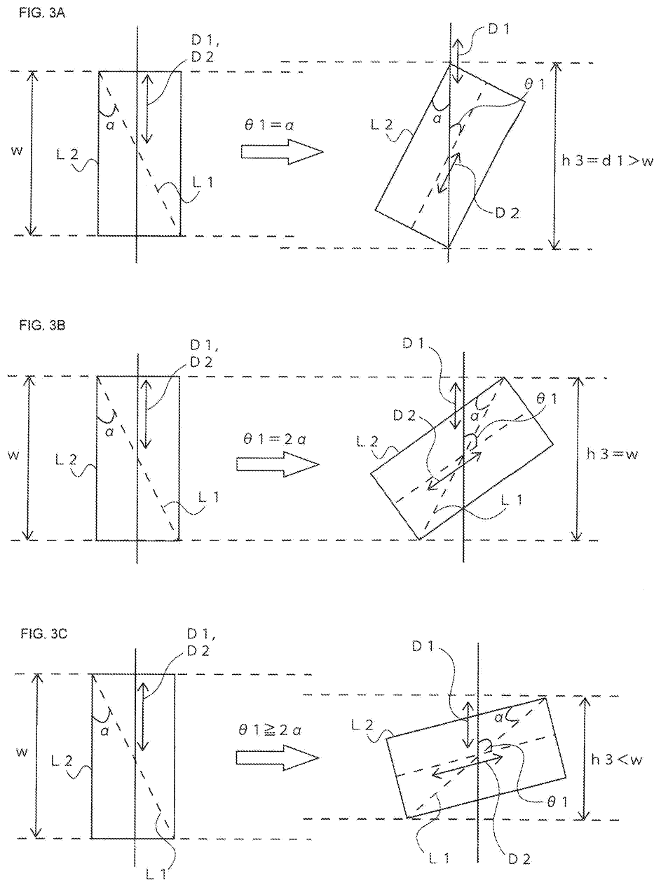

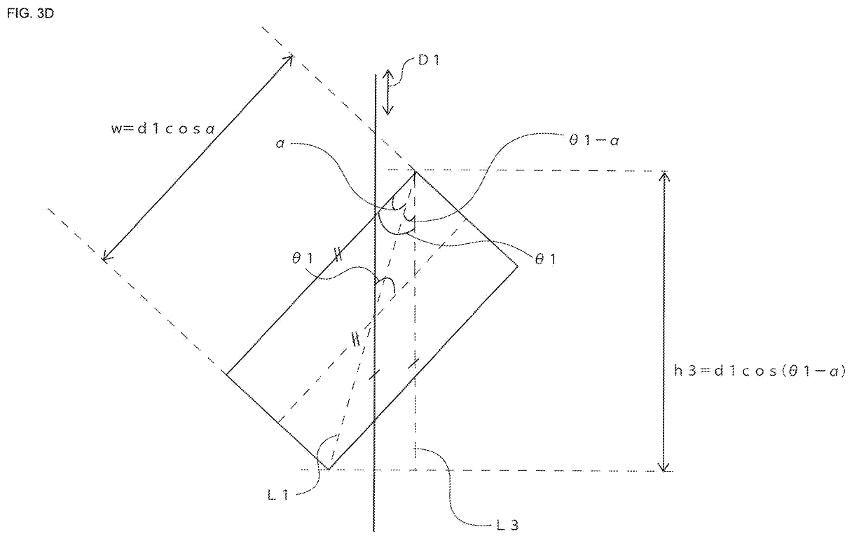

FIG. 1 is a perspective view illustrating an inductor according to a first embodiment of the present disclosure. FIG. 2 is a perspective view illustrating a coil in the inductor of FIG. 1. FIG. 3A is a view for explaining an extent of torsion of a lead portion of the coil in the inductor, in which the torsion angle is set to be equal to an angle between a diagonal and a width-wise side in a cross section of a conducting wire. FIG. 3B is another view for explaining the extent of torsion of the lead portion of the coil in the inductor, in which the torsion angle is set to be twice the angle between the diagonal and the width-wise side in the cross section of the conducting wire. FIG. 3C is another view for explaining the extent of torsion of the lead portion of the coil in the inductor, in which the torsion angle is set to be greater than twice the angle between the diagonal and the width-wise side in the cross section of the conducting wire. FIG. 3D is a view for explaining a relation between the torsion angle of the lead portion of the coil and the height of the lead portion in the inductor of FIG. 1.

The inductor 1 according to the present embodiment includes a main body 2 that has a magnetic portion 6 containing a magnetic powder and has a coil 8 embedded in the magnetic portion 6. The inductor 1 also includes a pair of external electrodes 4 that are formed on surfaces of the main body 2 and connected to the coil 8.

The coil 8 includes a winding portion 12 in which a conducting wire 100 having a pair of wide surfaces 10 is wound around a winding axis A. The coil 8 also includes a pair of lead portions 20 and 22 each of which continues to the winding portion 12. An end section (first end section) 14 of the winding portion 12 is positioned at the innermost turn of the winding portion 12. The other end section (second end section) 16 of the winding portion 12 is positioned at the outermost turn of the winding portion 12. The lead portion (first lead portion) 20 is the conducting wire drawn from the first end section 14 of the winding portion 12, and the other lead portion (second lead portion) 22 is the conducting wire drawn from the second end section 16 of the winding portion 12. The first lead portion 20 is twisted in a region surrounded by the innermost turn of the winding portion 12 and is drawn outward from the innermost turn of the winding portion 12 beyond the outermost turn of the winding portion 12. The coil 8 has the winding portion 12 and a pair of the lead portions 20 and 22 as described above, and a height h1 of the coil 8 in a crossing region 24 in which the first lead portion 20 crosses the winding portion 12 is set to be smaller than twice a height h2 of the winding portion 12.

The lead portions 20 and 22 are electrically connected to respective external electrodes 4.

Coil

As illustrated in FIGS. 1 and 2, the coil 8 includes the winding portion 12 formed by winding the conducting wire 100 and a pair of the lead portions 20 and 22 continuing to respective opposite end sections 14 and 16 of winding portion 12. The conducting wire 100 is a flat wire having a pair of opposite wide surfaces 10, and the cross section of the conducting wire 100 is shaped like a rectangle. The conducting wire 100 is a conductor covered by an insulating cover layer and a fusing layer formed on the cover layer.

Winding Portion

The winding portion 12 is formed by winding the conducting wire 100 in such a manner that the wide surfaces 10 of the conducting wire 100 are disposed substantially parallel to a winding axis A. The winding portion 12 is formed by winding the conducting wire 100 in one tier. The first end section 14 of the winding portion 12 is positioned at the innermost turn and the second end section 16 of the winding portion 12 is positioned at the outermost turn. In the winding portion 12, adjacent turns of the conducting wire 100 are brought into contact with each other with respective wide surfaces 10 coming into contact. For example, as in the coil 8 illustrated, an outside wide surface 10a of a first-turn conducting wire 100a, which is the innermost turn of the winding portion 12, is in contact with an inside wide surface 10b of a second-turn conducting wire 100b, which is the turn next to the innermost turn of the winding portion 12. The outside wide surface 10a and the inside wide surface 10b are adhered to each other by respective fusing layers.

Lead Portion

An end section 22a of the second lead portion 22 is bent such that the wide surfaces of the end section 22a are disposed substantially parallel to a side surface 2e of the main body 2, which will be described later.

The first lead portion 20 is twisted and drawn outward from the innermost turn the winding portion 12 of the coil 8 beyond the outermost turn thereof while crossing over an upper surface 12a of the winding portion 12 or crossing under a lower surface 12b of the winding portion 12. Here, part of the first lead portion 20 is in contact with the upper surface 12a or the lower surface 12b of the winding portion 12. The first lead portion 20 is twisted such that the height h1 of the coil 8 becomes smaller than twice the height h2 of the winding portion 12 in the crossing region 24 in which the first lead portion 20 crosses the winding portion 12. The term “height” as used herein is defined as length in the extending direction D1 of the winding axis A. The height h1 of the coil 8 in the crossing region 24 is a sum of the height h2 of the winding portion 12 and a height h3 of the first lead portion 20 in the crossing region 24. In the present embodiment, the height h2 of the winding portion 12 is equal to a width w of the conducting wire 100 since the conducting wire 100 is wound such that the wide surfaces 10 are disposed substantially parallel to the winding axis A in the winding portion 12. The above description can be expressed in the following formulae:

h1<2×h2

h1=h2+h3

h2=w

Accordingly, h3 can be expressed in terms of w as:

h3<w

Thus, the first lead portion 20 is twisted such that the height h3 in the crossing region 24 becomes smaller than the width w of the conducting wire 100.

Referring to FIG. 2 and FIGS. 3A to 3D, an extent of torsion of the first lead portion 20 will be specifically described by focusing on an angle (torsion angle) θ1 between the width-wise direction D2 of the first lead portion 20 in the crossing region 24 and the extending direction D1 of the winding axis A. Note that the torsion angle θ1 is set so as not to exceed 90°.

As described above, the conducting wire 100 has the rectangular cross section. Accordingly, as illustrated in FIGS. 3A to 3C, if the torsion angle θ1 is not large enough, the height h3 of the first lead portion 20 in the crossing region 24 becomes greater than the height of the untwisted first lead portion 20, in other words, greater than the width w of the conducting wire 100. More specifically, as in an example illustrated in FIG. 3A, if the torsion angle is equal to an angle α between a diagonal L1 and a width-wise side L2 in the cross section of the conducting wire 100, the height h3 of the first lead portion 20 is equal to a length d1 of the diagonal L1, which is greater than the width w of the conducting wire 100. On the other hand, as in an example illustrated in FIG. 3C, if the torsion angle is large enough, the first lead portion 20 is laid down further toward the horizontal position and the height h3 becomes smaller than the width w of the conducting wire 100.

Thus, the range of the torsion angle θ1 is set on the basis of the rectangular cross-sectional shape of the conducting wire 100. The range of the torsion angle can be obtained geometrically with reference to FIGS. 3A to 3D.

An example of obtaining the range of the torsion angle θ1 is described below.

As illustrated in FIG. 3D, when the length of the diagonal L1 is d1, the height h3 at a torsion angle θ1 can be expressed as:

h3=d1·cos(θ1−α)

This equation can be obtained easily by drawing an auxiliary line L3 that extends parallel to the extending direction D1 of the winding axis A and passes through a corner of the rectangle, which is the cross section of the conducting wire 100.

The width w of the conducting wire 100 is expressed as:

w=d1·cos α

When these are substituted into h3<w, the following inequality can be obtained:

d1·cos(θ1−α)<d1·cos

Therefore,

2α<θ1

Accordingly, in the present embodiment, the torsion angle θ1 of the first lead portion 20 is set to be in the range of 2α<θ1≤90°.

Moreover, within the range of 2α<θ1≤90°, the torsion angle θ1 is desirably determined by taking into account, for example, the rigidity of the conducting wire 100 to be used and stresses generated in the conducting wire 100 due to twisting.

For example, the conductor of conducting wire 100 of the coil 8 is made of copper and has a width of 140 μm or more and 170 μm or less (i.e., from 140 μm to 170 μm) and a thickness of 67 μm or more and 85 μm or less (i.e., from 67 μm to 85 μm). The cover layer of the conducting wire 100 is made of an insulating resin, such as polyamide-imide, and has a thickness of, for example, 1 μm or more and 7 μm or less (i.e., from 1 μm to 7 μm), preferably 6 μm. The fusing layer of the conducting wire 100 is made of a thermoplastic resin or a thermosetting resin that includes an autohesion ingredient, and the fusing layer is provided for fixing adjacent turns of the conducting wires of the winding portion 12 together. The fusing layer has a thickness, for example, of 1 μm or more and 3 μm or less (i.e., from 1 μm to 3 μm), preferably 1.5 μm. The conducting wire 100 of the coil 8 has a width w of, for example, 144 μm or more and 190 μm or less (i.e., from 144 μm to 190 μm) and a thickness of, for example, 71 μm or more and 105 μm or less (i.e., from 71 μm to 105 μm).

Magnetic Portion

As illustrated in FIG. 1, the magnetic portion 6 has the coil 8 embedded therein, and an end section 20a of the first lead portion 20 and the end section 22a of the second lead portion 22 are exposed from the magnetic portion 6. Note that the first lead portion 20 may be also bent, as is the second lead portion 22, along a surface of the magnetic portion 6 so as to expose a wide surface of the first lead portion 20 from the magnetic portion 6.

The magnetic portion 6 is formed by pressing a mixture of a magnetic powder and a resin. The magnetic powder content of the mixture is, for example, 60 weight % or more, preferably 80 weight % or more. A type of magnetic powder to be used is an iron-based magnetic powder, for example, composed of Fe, Fe—Si—Cr, Fe—Ni—Al, Fe—Cr—Al, Fe—Si, Fe—Si—Al, Fe—Ni, or Fe—Ni—Mo, an other metal-based magnetic powder, an amorphous metal-based magnetic powder, a magnetic powder of which surfaces of metal particles are coated with an insulator such as glass, a magnetic powder of which surfaces of metal particles are modified, or a magnetic powder composed of nano-level minute metal particles. A type of resin to be used is a thermosetting resin, such as epoxy resin, polyimide resin, and phenol resin, or a thermoplastic resin, such as polyethylene resin and polyamide resin.

Main Body

As described above, the main body 2 includes the coil 8 and the magnetic portion 6. In external appearance, the main body 2 is shaped like a cuboid having, for example, a width of 1.4 mm to 2.2 mm, a depth of 0.6 mm to 1.8 mm, and a height of 0.6 mm to 1.4 mm

External Electrode

The external electrodes 4 are a pair of electrodes for external connection. The external electrodes 4 are formed on surfaces of the main body 2 so as to be spaced from each other. In the present embodiment, one of the external electrodes 4 covers a side surface 2c and part of adjacent side surfaces 2a, 2b, 2d, and 2f of the main body 2 and is electrically connected to the end section 20a of the first lead portion 20. The other one of the external electrodes 4 covers the side surface 2e and part of adjacent side surfaces 2a, 2b, 2d, and 2f of the main body 2 and is electrically connected to the end section 22a of the second lead portion 22. The external electrodes 4 are made, for example, of a conductive resin that contains metal particles and a resin. Silver particles are used as the metal particles, and epoxy resin is used as the resin. The external electrodes 4 may further include a plating layer formed on the conductive resin containing the metal particles and the resin. The plating layer may have a first layer made of nickel and a second layer formed on the first layer and made of tin.

### Advantageous Effect

In the inductor configured as described above, the winding portion 12 is formed by winding the conducting wire 100 in one tier, and the first lead portion 20 is twisted such that the height h3 of the coil 8 becomes smaller than twice the height h1 of the winding portion 12 in the crossing region 24. The height of the coil 8 can be thereby reduced, which leads to a reduction in the size of the inductor.

Moreover, in the inductor configured as described above, the first-turn conducting wire 100a and the second-turn conducting wire 100b of the coil 8 are adhered to each other by respective fusing layers in such a manner that the corresponding inside wide surface 10a and the corresponding outside wide surface 10b are adhered to each other, which provides a wide adhesion area for the adhesion of adjacent turns of the conducting wire. Thus, the turns of conducting wire of the coil 8 can be adhered sufficiently, which can prevent the coil 8 from loosening.

The inductor configured as described above includes the main body 2 having the magnetic portion 6 containing a magnetic powder and the coil 8 embedded in the magnetic portion 6 and also includes a pair of the external electrodes 4 disposed on the main body 2 and electrically connected to the coil 8. The coil 8 has the winding portion 12 in which the conducting wire 100 having a pair of the wide surfaces 10 are wound around the winding axis in such a manner that one end section 14 is disposed at the innermost turn of the winding portion 12 and the other end section 16 is disposed at the outermost turn of winding portion 12. The coil 8 has the first lead portion 20 in which the conducting wire drawn from the one end section 14 of the winding portion 12 is twisted and drawn outward of winding portion from the innermost turn beyond the outermost turn of winding portion and also has the second lead portion 22 in which the conducting wire drawn from the other end portion 16 of the winding portion 12 is drawn outward from the outermost turn of winding portion. The height h1 of the coil 8 in the crossing region 24 in which the first lead portion 20 crosses the winding portion 12 is smaller than twice the height h2 of the winding portion 12.

### 2. Second Embodiment

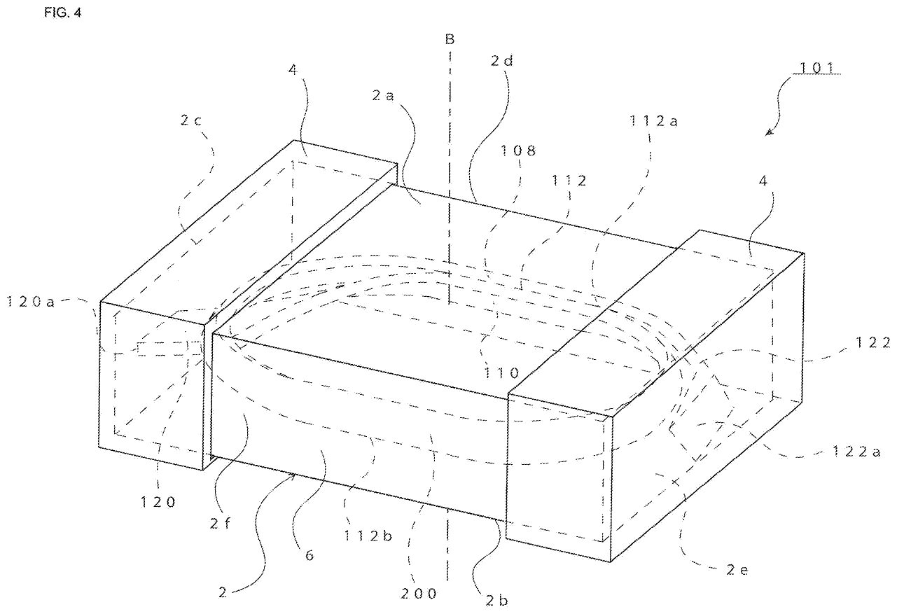

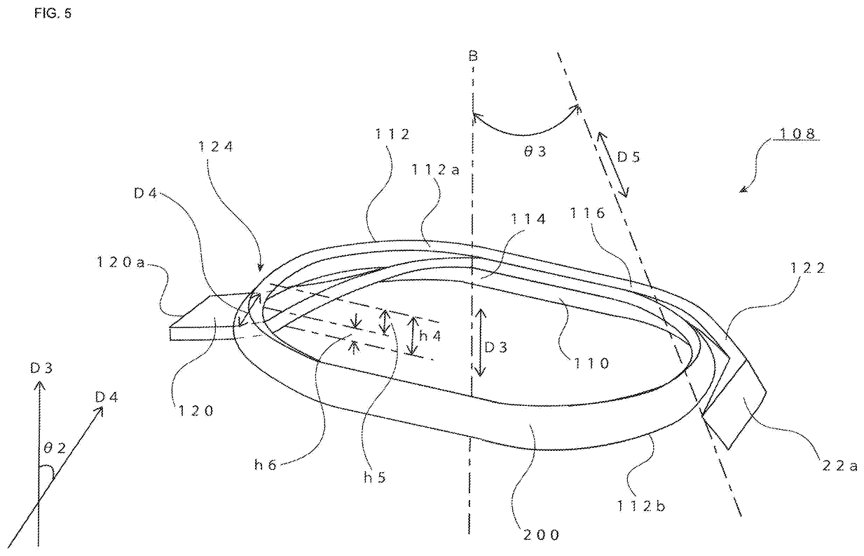

Next, an inductor 101 according to the second embodiment will be described with reference to FIGS. 4 and 5. FIG. 4 is a perspective view illustrating the inductor according to the second embodiment of the present disclosure. FIG. 5 is a perspective view illustrating a coil of the inductor of FIG. 4.

In the inductor 101 according to the second embodiment, the width-wise direction D5 of wide surfaces 110 of a winding portion 112 with respect to the extending direction D3 of a winding axis B is different from that of the inductor 1 according to the first embodiment. The wide surfaces 10 of winding portion 12 of the inductor 1 are disposed so as to be substantially parallel to the winding axis A, whereas the wide surfaces 110 of winding portion 112 of the inductor 101 are disposed so as to incline with respect to the winding axis B. In other words, the winding portion 112 is inclined toward the horizontal position.

An angle of inclination θ3 of the wide surfaces 110 with respect to the winding axis B is set to be in the range of 2α≤θ3≤90°, and preferably, in the range of 2α≤θ3≤90°. The reason for this is the same as that described in the first embodiment in relation to the range of the torsion angle θ1. When the wide surfaces 110 are inclined with respect to the winding axis B, if the height h5 of the winding portion 112 becomes greater than that before inclining the wide surfaces 110, this is not suitable for the object of the present disclosure. Accordingly, the angle of inclination θ3 is set to be in the range of 2α≤θ3≤90°, preferably, in the range of 2α≤θ3<90°. Note that the angle α here is the same as the angle α of the first embodiment.

As the angle of inclination θ3 increases, the cross-sectional area of a coil 108 (area surrounded by the innermost turn of a conducting wire 200 in the winding portion 112) decreases, which lowers the inductance of the coil. Accordingly, the angle of inclination θ3 is determined by taking into account, for example, a desired inductance, a desired height of the coil, and a width of the conducting wire 200.

In addition, as illustrated in FIG. 5, the winding portion 112 is inclined in such a manner that the distance between an upper surface 112a of the winding portion 112 and the winding axis B is smaller than the distance between a lower surface 112b of the winding portion 112 and the winding axis B in the case of a first lead portion 120 being drawn outward under a lower surface 112b of the winding portion 112. In other words, the winding portion 112 is tapered from the lower surface 112b toward the upper surface 112a. Alternatively, in the case of the first lead portion 120 being drawn outward over the upper surface 112a of the winding portion 112, the winding portion 112 is inclined in such a manner that the distance between the upper surface 112a of the winding portion 112 and the winding axis B is greater than the distance between the lower surface 112b of the winding portion 112 and the winding axis B. In other words, the winding portion 112 is tapered from the upper surface 112a toward the lower surface 112b.

Moreover, the inductor 101 according to the second embodiment has a range of a torsion angle θ2, which is the angle between a width-wise direction D4 of the first lead portion 120 in a crossing region 124 and the extending direction D3 of the winding axis B. The range of the torsion angle θ2 is different from the torsion angle θ1 of the first embodiment since the wide surfaces 110 of the conducting wire 200 incline with respect to the winding axis B.

The range of the torsion angle θ2 according to the present embodiment is set in the following manner.

The first lead portion 120 is twisted such that a height h4 of the coil 108 in the crossing region 124 becomes smaller than twice a height h5 of the winding portion 112 as is the case for the first embodiment. The height h4 of the coil 108 in the crossing region 124 is a sum of the height h5 of the winding portion 112 and a height h6 of the first lead portion 120 in the crossing region 124. The above description can be expressed in the following formulae:

h4<2×h5

h4=h5+h6

Accordingly, the relation between h6 and h5 is:

h6<h5

Thus, the first lead portion 120 is twisted such that the height h6 in the crossing region 124 becomes smaller than the height h5 of the winding portion 112.

In the present embodiment, as described above, the angle of inclination θ3 is set to be in the range of 2α≤θ3≤90°, preferably, in the range of 2α≤θ3<90°. Accordingly, it is necessary to lay the first lead portion 120 down more to the horizontal position than the winding portion 112 in order to decrease the height h6 of the first lead portion 120 in the crossing region 124 to a level less than the height h5 of the winding portion 112. This can be done by setting the torsion angle θ2 to be greater than the angle of inclination θ3. Accordingly, in the present embodiment, the torsion angle θ2 is set to be in a range of θ3<θ2≤90° (where 2α≤θ3≤90° or preferably 2α≤θ3<90°). Note that in the present embodiment, the torsion angle θ2 is desirably determined within the range of θ3<θ2≤90° (where preferably 2α≤θ3<90°) by taking into account, for example, the rigidity of the conducting wire 200 to be used and stresses generated in the conducting wire 200 due to twisting.

### Advantageous Effect

The inductor configured as above has the wide surfaces 110 of winding portion 112 that incline with respect to the winding axis B. The height of the coil 108 can be reduced, which leads to a reduction in the size of the inductor.

### 3. Manufacturing Method

Next, a method of manufacturing the inductors according to the above embodiments will be described.

The method of manufacturing the inductors according to the above embodiments includes 1) a step of forming a coil, 2) a step of forming a main body, and 3) a step of forming external electrodes. These steps will be described in detail below.

Step of Forming Coil

In this step, a coil having a winding portion and lead portions is formed. The coil is formed of a conducting wire having a pair of opposite wide surfaces (so-called “flat wire”). The conducting wire has a conductor, a cover layer having insulation properties formed on the surface of the conductor, and a fusing layer formed on the surface of the cover layer. The winding portion is formed by winding the conducting wire in such a manner that a first end section is positioned at the innermost turn of the winding portion, a second end section is positioned at the outermost turn of winding portion, and respective wide surfaces of adjacent turns of the conducting wire are brought into contact with each other. The turns of the conducting wire are adhered to each other by the fusing layers. Here, the coil 8 according to the first embodiment can be formed by winding the conductive wire such that the wide surfaces are disposed so as to be parallel to the winding axis, whereas the coil 108 according to the second embodiment can be formed by winding the conductive wire such that the wide surfaces are disposed so as to incline with respect to the winding axis.

Next, a first lead portion is formed by twisting the conducting wire drawn from the end section of the winding portion in such a manner that the torsion angle of the end section in the crossing region with respect to the winding axis is in a predetermined range and subsequently by drawing the twisted end section outward from the innermost turn of the winding portion beyond the outermost turn of the winding portion. A second lead portion is formed by the conducting wire drawing from the other end section of the winding portion from the outermost turn of the winding portion.

Step of Forming Main Body

In this step, the coil is placed in a cavity of a die, and the cavity is filled with a mixture of a magnetic powder and a resin. Here, the coil is desirably placed in the cavity such that the end portion of the first lead portion and the end portion of the second lead portion come into contact with respective side surfaces of the cavity. The mixture of the magnetic powder and the resin in the die is heated to a temperature higher than a softening temperature of the resin (for example, 60° C. to 150° C.). In this state, the mixture is molded and cured by pressing the mixture at an approximate pressure of 100 kg/cm² to 500 kg/cm² while heating the mixture to a temperature higher than a curing temperature of the resin (for example, 100° C. to 220° C.). The magnetic portion and the coil are thereby integrated into one piece, which forms a main body with the first lead portion and the second lead portion being exposed from side surfaces of the main body. Note that the curing may be carried out after the molding is completed.

Step of Forming External Electrodes

In this step, the side surfaces of the main body from which respective end section of the first lead portion and the second lead portion are exposed are formed, and a pair of external electrodes that are spaced from each other are formed so as to cover the above side surfaces and part of the other four side surfaces adjacent thereto. The external electrodes are formed by applying, by way of dipping, a fluid conductive resin, such as a conductive paste, to a desired portion of the main body. The external electrodes may be formed by metal plating on the surface of the conductive resin applied. A nickel layer on the conductive resin and a tin layer on the nickel layer are formed by metal plating.

### OTHER EMBODIMENTS

The present disclosure can be applied to cases in which in the first and second embodiments, the winding portion is formed by winding the conducting wire spirally by multiple turns, such as two turns or three turns. In addition, in the second embodiment, the wide surfaces 110 has been described, by way of example, as inclining with respect to the winding axis B in the entire circumference of winding portion of the coil. However, the wide surfaces 110 may incline with respect to the winding axis B in only part of the circumference of winding portion of the coil. Moreover, in the first and second embodiments, the coil may be disposed upside down in the main body.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An inductor comprising:
a main body having a magnetic portion containing a magnetic powder and a coil embedded in the magnetic portion; and
a pair of external electrodes disposed on the main body and electrically connected to the coil,
wherein the coil has
a winding portion in which a conducting wire having a pair of wide surfaces are wound around a winding axis in such a manner that one end section is disposed at an innermost turn of the winding portion and the other end section is disposed at an outermost turn of the winding portion,
a first lead portion in which the conducting wire drawn from the one end section of the winding portion is twisted and drawn outward of the winding portion from the innermost turn beyond the outermost turn of the winding portion, and
a second lead portion in which the conductive wire drawn from the other end section of the winding portion is drawn outward from the outermost turn of the winding portion, and
a height of the coil in a crossing region in which the first lead portion crosses the winding portion is smaller than twice a height of the winding portion.

2. The inductor according to claim 1, wherein
a torsion angle between a width-wise direction of the first lead section in the crossing region and an extending direction of the winding axis of the winding portion does not exceed 90° and is greater than twice an angle between a diagonal and a width-wise side of a cross-sectional shape of the conducting wire.

3. The inductor according to claim 1, wherein
the wide surfaces of the conducting wire in the winding portion are disposed parallel to the winding axis.

4. The inductor according to claim 1, wherein
the wide surfaces of the conducting wire in the winding portion are disposed to incline with respect to the winding axis.

5. The inductor according to claim 2, wherein
the wide surfaces of the conducting wire in the winding portion are disposed parallel to the winding axis.

6. The inductor according to claim 2, wherein
the wide surfaces of the conducting wire in the winding portion are disposed to incline with respect to the winding axis.
